(19) United States
(12) Patent Application Publication
(10) Pub. No.: US 2013/0318389 A1
(43) Pub. Date: Nov. 28, 2013

(54) POWER SUPPLY MANAGEMENT SYSTEM AND METHOD

(71) Applicants: HON HAI PRECISION INDUSTRY CO., LTD., New Taipei (TW); HONG FU JIN PRECISION INDUSTRY (Shenzhen) CO., LTD, Shenzhen (CN)

(72) Inventors: WEI-DONG CONG, Shenzhen (CN); KANG WU, Shenzhen (CN)

(21) Appl. No.: 13/902,882

(22) Filed: May 27, 2013

(30) Foreign Application Priority Data
May 28, 2012 (CN) 2012101682600

(51) Int. Cl. G06F 1/28

(52) U.S. Cl. CPC G06F 1/28
USPC 713/340

(57) ABSTRACT

A power supply management system includes a number of motherboards, a number of power supply units (PSUs), a number of sampling units, and a processor. Each sampling unit is being coupled between a motherboard and a PSU, and outputting a signal as to a normal or abnormal power supply. Thus in the event of a PSU malfunction, the processor identifies the motherboard which is consuming the greatest amount of power, and outputs an alarm to the identified motherboard to reduce the level of power being consumed by that motherboard.

### BACKGROUND

1. Technical Field

The present disclosure relates to a power supply management system.

2. Description of Related Art

One or more power supply units (PSUs) may be employed to provide power to a plurality of motherboards arranged in a server, to keep the server operating normally even if one of the PSUs malfunctions. However, when the one PSU malfunctions, and a total power consumption of the motherboards of the server exceeds a maximum power that the remaining normally-operating PSUs can provide, service lives of the PSUs may be reduced, which may reduce stability of the server.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a power supply management system of the present disclosure.

FIG. 2 is a flow chart of an embodiment of a power supply management method of the present disclosure.

### DETAILED DESCRIPTION

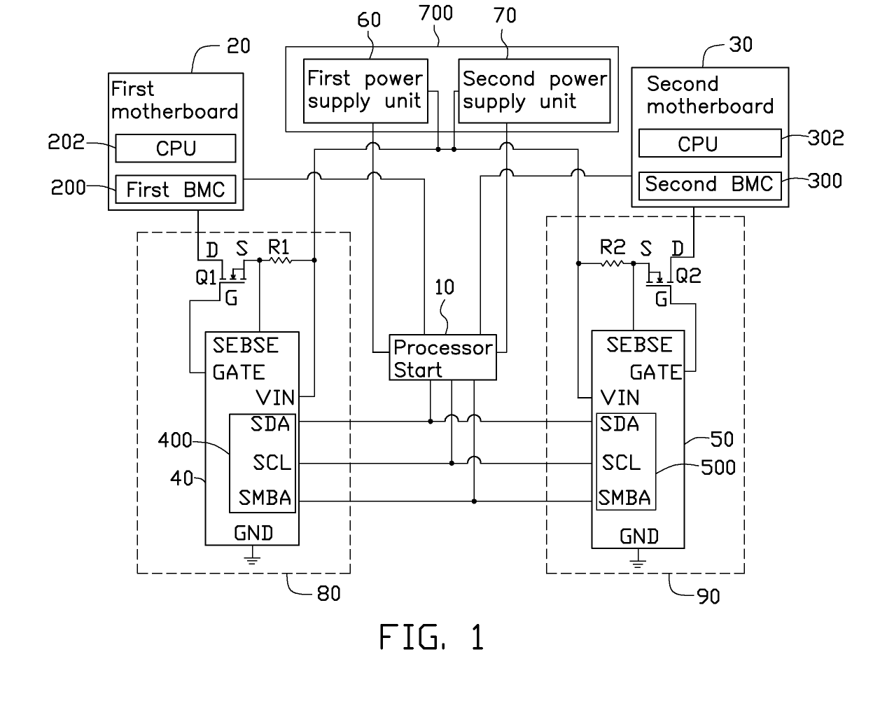

FIG. 1 shows an embodiment of a power supply management system of the present disclosure. The power supply management system includes a power unit 700, a first motherboard 20, a second motherboard 30, a first sampling unit 80 coupled to the first motherboard 20, a second sampling unit 90 coupled to the second motherboard 30, and a processor 10. The first and second motherboards 20 and 30 are arranged in a server, such as a personal computer or a mobile device.

The power unit 700 includes a plurality of power supply units (PSU). In the illustrated embodiment, the power unit 700 includes a first PSU 60 and a second PSU 70. The first and second PSUs 60 and 70 have an inbuilt redundancy power function. According to a working principle of the PSU, when the PSU is connected to an external mains power source, the PSU will output a standby voltage as a high level first status signal, such as logic 1, if the PSU is working normally; when the PSU malfunctions, the PSU will not output any voltage even if the PSU is connected to an external mains power source. Thus, when the PSU malfunctions, the PSU outputs a logic 0 signal as a low level second status signal. In other embodiments, other means may be used to determine whether the PSU malfunctions or not. The first and second power supply units 60 and 70 are both connected to the processor 10.

The first motherboard 20 includes a first baseboard management controller (BMC) 200 and a plurality of electronic elements 202, and the second motherboard 30 includes a second BMC 300 and a plurality of electronic element 302. Each of the first and second BMCs 200 and 300 adjusts the operation frequency or operation speed of the electronic elements of the motherboard on which the BMC is arranged. In one embodiment, the electronic elements of the motherboard are central processing units (CPUs) 202 and 302.

The first sampling unit 80 includes a first sampling chip 40, a first electronic switch Q1, and a resistor R1. A power input pin VIN of the first sampling chip 40 is coupled to an output terminal of the first and second power supply units 60 and 70, and is also coupled to a first terminal of the first electronic switch Q1 through the resistor R1. The first terminal of the first electronic switch Q1 is also coupled to a sensing pin SEBSE of the first sampling chip 40. A drive pin GATE of the first sampling chip 40 is coupled to a second terminal of the first electronic switch Q1. A third terminal of the first electronic switch Q1 is coupled to the first motherboard 20. A ground pin GND of the first sampling pin 40 is connected to ground. The second sampling unit 90 includes a second sampling chip 50, a second electronic switch Q2, and a resistor R2. A power input pin VIN of the second sampling chip 50 is coupled an output terminal of the first and second power supply units 60 and 70, and is also coupled to a first terminal of the second electronic switch Q2 through the resistor R2. The first terminal of the second electronic switch Q2 is coupled to a sensing pin SEBSE of the second sampling chip 50. A drive pin GATE of the second sampling chip 50 is coupled to a second terminal of the second electronic switch Q2. A third terminal of the second electronic switch Q2 is coupled to the second motherboard 30. A ground pin GND of the second sampling chip 50 is connected to ground. Each of the first and second sampling chips 40 and 50 includes a power management bus (PMbus) interface. For example, the first sampling chip 40 includes a first PMbus interface 400, and the second sampling chip 50 includes a second PMbus interface 500. Each of the PMbus interfaces 400 and 500 includes a data signal pin SDA, a clock signal pin SCL, and an alarm signal pin SMBU. The first and second sampling chips 40 and 50 communicate with the processor 10 through the PMbus interfaces.

When the second terminals of the first and second electronic switches Q1 and Q2 receive high level signals, the first and second electronic switches Q1 and Q2 are turned on, and the first terminals of the first and second electronic switches Q1 and Q2 are connected to the respective third terminals of the first and second electronic switches Q1 and Q2. When the second terminals of the first and second electronic switches Q1 and Q2 receive low level signals, the first and second electronic switches are turned off, and the first terminals of the first and second electronic switches Q1 and Q2 are disconnected from the third terminals of the same switches. In the illustrated embodiment, the first and second electronic switches Q1 and Q2 are n-channel metal oxide semiconductor field-effect transistors (NMOSFETs), where the gates, drains, and sources of the n-channel metal oxide semiconductor field-effect transistors are respectively the second, third, and first terminals of the electronic switches Q1 and Q2.

The first and second sampling chips 40 and 50 calculate the power consumption of the connected motherboards 20 and 30 by measuring currents through the resistors R1 and R2 through the sensing pins SEBSE, and output power signals in relation to the motherboards 20 and 30.

The processor 10 obtains the status signals of the PSUs arranged in the power unit 700, and determines whether a PSU is malfunctioning. According to the status signals, when a PSU is malfunctioning, the processor 10 receives the second status signal. The processor 10 then obtains power signals in relation to all the motherboards through the PMbus interfaces, and determines whether the total power consumption of all the motherboards 20 and 30 exceeds a predetermined value, where the predetermined value equals total power consumption of all the PSUs operating normally. If the total power consumption exceeds the predetermined value, the remaining normally-operating PSUs may be operating above a safe performance limit. Hence, the operating frequency of the electronic elements needs to be decreased to reduce the total power consumption of all motherboards 20 and 30. The processor 10 determines an identity of the motherboard which is consuming the greatest amount of power amongst the motherboards 20 and 30, and outputs an alarm signal to the identified motherboard. The BMC of the identified motherboard adjusts the operating frequency of the electronic elements of the identified motherboard, to decrease the amount of power being consumed by the identified motherboard.

In other embodiments, when the total power consumption of the server exceeds the predetermined value, the processor 10 may determine that two or more motherboards are consuming substantially equal amounts of power, and that the substantially equal amounts of power are the greatest amounts of power being consumed. In such a situation, the processor 10 randomly sets one of the two or more motherboards to be designated as the motherboard which has been identified for power reduction purposes, and outputs the alarm signal to designated motherboard.

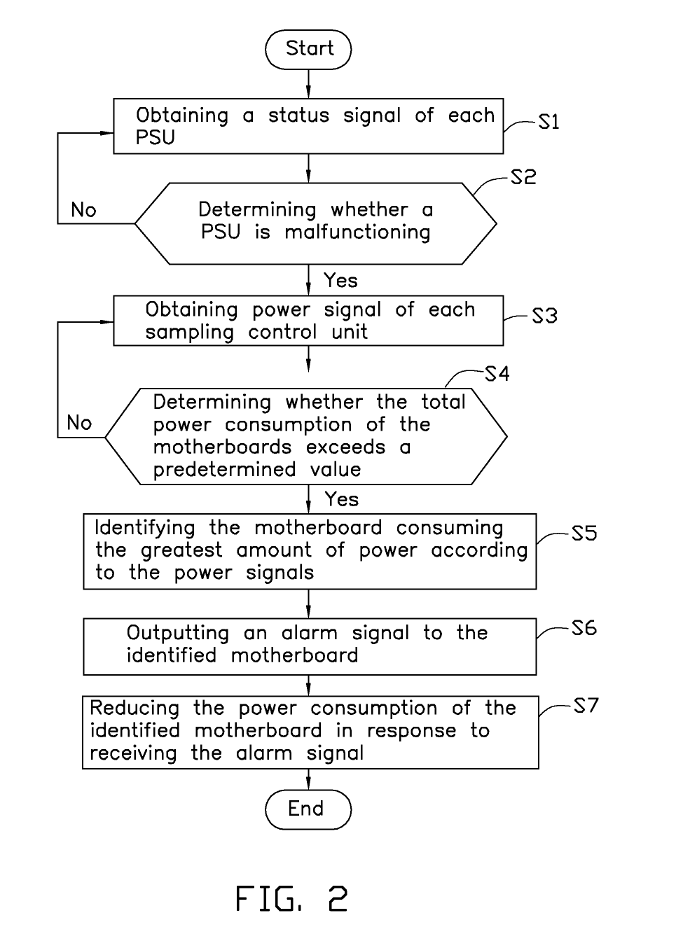

FIG. 2 shows a power supply method of the present disclosure. The power supply method includes the following steps.

In step S1, the processor 10 obtains the status signals of the PSUs in the power unit 700.

In step S2, the processor 10 determines whether a PSU is malfunctioning. When the processor 10 receives at least one second status signal, a determination is made that at least one PSU in the power unit 700 is malfunctioning, and the process goes to step S3. When the processor 10 does not receive any second status signal, it means all the PSUs are operating normally, and the process returns to step S1.

In step S3, the processor 10 obtains power signals from the sampling units connected to the motherboards which receive power from the PSUs.

In step S4, the processor 10 determines whether the total power consumption of the motherboards combined exceeds a predetermined value. If the total power consumption exceeds the predetermined value, step S5 is implemented. Otherwise, the process returns to step S3.

In step S5, the processor 10 identifies the motherboard consuming the greatest amount of power according to the power signals.

In step S6, the processor 10 outputs an alarm signal to the identified motherboard.

In step S7, the BMC of the identified motherboard reduces the power consumption of the identified motherboard by reducing the operating frequency of the motherboard.

In other embodiments, in step S6, the processor 10 also determines whether two or more motherboards are consuming approximately equal amounts of power, where the approximately equal amounts of power are the greatest amounts being consumed, and the processor 10 will designate one of the two or more motherboards as the motherboard which has been identified for power reduction purposes and output the alarm to the motherboard so identified.

While the disclosure has been described by way of example and in terms of a preferred embodiment, it is to be understood that the disclosure is not limited thereto. On the contrary, it is intended to cover such various modifications and similar arrangements as would be apparent to those skilled in the art. Therefore, the range of the appended claims should be accorded the broadest interpretation so as to encompass all such modifications and similar arrangements.

What is claimed is:

1. A power supply management system, comprising:
a plurality of motherboards;
a power unit comprising a plurality of power supply units (PSUs), wherein each PSU outputs a first status signal responsive to the PSU operating normally, or outputs a second status signal responsive to the PSU malfunctioning;
a sampling unit coupled between each motherboard and a corresponding PSU, configured to output a power signal of the motherboard; and
a processor configured to obtain the first or second status signals of the PSUs, wherein when the processor receives at least one second status signal, the processor obtains the power signals of the plurality of motherboards, and determines whether a total power consumption of the plurality of motherboards exceeds a predetermined value; if the total power consumption exceeds the predetermined value, the processor identifies a motherboard consuming a greatest power amongst the plurality of motherboards, and outputs an alarm signal to the identified motherboard, wherein the identified motherboard reduces the power consumption responsive to receiving the alarm signal.

2. The power supply management system of claim 1, wherein the each of the plurality of motherboards comprises a baseboard management system (BMC), the BMC is configured to reduces the power consumption of the identified motherboard responsive to receiving the alarm signal.

3. The power supply management system of claim 2, wherein the BMC decreases operating frequencies of electronic elements of the identified motherboard responsive to receiving the alarm signal.

4. The power supply management system of claim 2, wherein response to the processor determining that two or more motherboards are consuming approximately equal greatest amounts of power, the processor outputs the alarm signal to one of the two or more motherboards.

5. The power supply management system of claim 4, wherein the predetermined value equals the total power consumption of the PSUs operating normally.

6. The power supply management system of claim 5, wherein each sampling unit comprises an electronic switch, a sampling chip, and a resistor, a first terminal of the electronic switch is coupled to one of the plurality of motherboards, a second terminal of the electronic switch is coupled to a drive pin of the sampling chip, a third terminal of the electronic switch is coupled to one of the plurality of PSUs through the resistor, and coupled to a power input pin of the sampling chip through the resistor, when the second terminal of the electronic switch receives a high level voltage, the first and third terminals of the electronic switch are connected to each other, when the second terminal of the electronic switch receives a low level voltage, the first and third terminals of the electronic switch are disconnected from each other.

7. The power supply management system of claim 6, wherein the electronic switches of the sampling units are n-channel metal oxide semiconductor field-effect transistors (NMOSFETs), the gates, drains, and sources of the NMOSFETs are respectively the second, first, and third terminals of the electronic switches.

8. The power supply management system of claim 7, wherein each sampling chip comprises a power management bus interface, the sampling chip communicates with the processor through the power management bus interface.

9. A power supply management method for a plurality of power supply units (PSUs), comprising:
obtaining a status signal of each PSU;
determining whether a PSU is malfunctioning;
obtaining power signals from a plurality of sampling units coupled between the PSUs and a plurality of motherboards in response to at least one motherboard being malfunctioned;
determining whether a total power consumption of the plurality of motherboards exceeds a predetermined value;
identifying a motherboard consuming the greatest amount of power amongst the plurality of motherboards according to the power signals, in response to the total power consumption exceeding the predetermined value;
outputting an alarm signal to the identified motherboard; and
reducing the power consumption of the identified motherboard in response to the motherboard receiving the alarm signal.

10. The power supply management method of claim 9, further comprising:
determining whether two or more motherboards are consuming approximately equal greatest amounts of power, in response to the total power consumption exceeding the predetermined value; and
designating one of the two or more motherboards as the identified motherboard.

11. The power supply management method of claim 10, wherein each of the plurality of motherboards comprises a baseboard management system (BMC), the BMC is configured to decrease the power of the corresponding motherboard responsive to receiving the alarm signal.

12. The power supply management method of claim 11, wherein if the total power consumption does not exceed the predetermined value, the process returns to the step of obtaining power signals from a plurality of sampling units coupled between the PSUs and a plurality of motherboards.

13. The power supply management method of claim 12, wherein the predetermined value equals a total power consumption of all of the plurality of PSUs operating normally.
